(19) United States
(12) Patent Application Publication
(10) Pub. No.: US 2024/0154877 A1
(43) Pub. Date: May 9, 2024

(54) SYSTEMS AND METHODS FOR INCIDENT RESPONSE USING ARTIFICIAL INTELLIGENCE FOR INFORMATION TECHNOLOGY OPERATIONS

(71) Applicant: JPMORGAN CHASE BANK, N.A., New York, NY (US)

(72) Inventors: Ajayaghosh L, London (GB); Vineet K SHARMA, Sunnyvale, CA (US); Guangjing CHEN, Palo Alto, CA (US); David ZHANG, Palo Alto, NY (US); Nivead APPUKUTTAN, Santa Clara, CA (US); Xiaobo HUANG, Morgan Hill, CA (US)

(21) Appl. No.: 18/053,235

(22) Filed: Nov. 7, 2022

(51) Int. Cl. H04L 41/16; G06N 5/022; H04L 41/06

(52) U.S. Cl. CPC H04L 41/16; G06N 5/022; H04L 41/06

(57) ABSTRACT

Systems and methods for incident response using artificial intelligence for information technology operations are disclosed. In one embodiment, a method may include an incident response computer program executed by an electronic device: (1) receiving an incident ticket for an incident involving a computer product or a computer system within an organization from a service management platform for the computer product or the computer system; (2) providing incident information from the incident ticket to a trained incident response machine learning engine, wherein the trained incident response machine learning engine is trained to predict a solution for the incident based on historical incident data; (3) receiving, from the trained incident response machine learning engine, a predicted solution for the incident; and (4) providing the predicted solution to the service management platform. The service management platform provides the predicted solution to the computer product or the computer system.

### BACKGROUND OF THE INVENTION

### 1. Field of the Invention

Embodiments generally relate to systems and methods for incident response using artificial intelligence for information technology operations.

### 2. Description of the Related Art

In large organizations, Information Technology (IT) response teams receive a large volume of incident tickets daily. The volume can be so large that it cannot be addressed just by increasing the team size.

### SUMMARY OF THE INVENTION

Systems and methods for incident response using artificial intelligence for information technology operations are disclosed. In one embodiment, a method for incident response using artificial intelligence for information technology operations may include: (1) receiving, by an incident response computer program executed by an electronic device, an incident ticket for an incident involving a computer product or a computer system within an organization from a service management platform for the computer product or the computer system; (2) providing, by the incident response computer program, incident information from the incident ticket to a trained incident response machine learning engine, wherein the trained incident response machine learning engine is trained to predict a solution for the incident based on historical incident data; (3) receiving, by the incident response computer program and from the trained incident response machine learning engine, a predicted solution for the incident; and (4) providing, by the incident response computer program, the predicted solution to the service management platform. The service management platform provides the predicted solution to the computer product or the computer system.

In one embodiment, the incident ticket may identify a description of the incident and/or a labelling of product/incident type.

In one embodiment, the method may also include training the trained incident response machine learning engine by retrieving, by the incident response computer program, the historical incident data comprising a plurality of prior incidents; training, by the incident response computer program, the trained incident response machine learning engine using a first portion of the historical incident data; verifying, by the incident response computer program, the training of the trained incident response machine learning engine using a second portion of the historical incident data; and deploying, by the incident response computer program, the verified incident response machine learning engine to a production environment.

In one embodiment, for each of the plurality of prior incidents, the historical incident data may include a description of the prior incident, a labelling of a product involved in the prior incident, a system involved in the prior incident, an individual involved in the prior incident, a team involved in the prior incident, a time and date of the prior incident, solutions to the prior incident, results of the solution, network environment data at the time of the prior incident, etc.

In one embodiment, the predicted solution may include a self-service troubleshooting guide for the predicted solution, product frequently asked questions (FAQs) for the predicted solution, solution instructions for the predicted solution, scripts for the predicted solution, patches for the predicted solution, configurations for the predicted solution, and/or solution articles for the predicted solution.

In one embodiment, the method may also include: receiving, by the incident response computer program, feedback for the predicted solution; and re-training, by the incident response computer program, the trained incident response machine learning engine with the feedback.

According to another embodiment, a method for incident response using artificial intelligence for information technology operations may include: (1) receiving, by an incident response computer program executed by an electronic device, a plurality of incident tickets for incidents involving computer products or computer systems within an organization from a service management platform for the computer products or the computer systems; (2) predicting, by the incident response computer program executed by an electronic device and using a trained incident response machine learning engine that is trained to predict a category for each incident ticket, a category for each of the plurality of incident tickets; (3) clustering, by the incident response computer program, the plurality of incident tickets into common incident clusters according to the categories; (4) ranking, by the incident response computer program, the common incident clusters based on a number of incident tickets in each common incident cluster; and (5) prioritizing, by the incident response computer program, improvement of production quality for programs or applications based on the ranking.

In one embodiment, the incident ticket may identify a description of the incident and/or a labelling of product/incident type.

In one embodiment, the categories may include a common issue, a common software program, a common computer system, a common geography, and a common solution.

In one embodiment the common incident clusters may also be ranked based on a severity or impact of the incident in each common incident cluster.

According to another embodiment, a system may include a plurality of computer products or computer systems; a service management platform in communication with each of the plurality of computer systems; a solution knowledge base; and an electronic device executing an incident response computer program and a trained incident response machine learning engine. The incident response computer program receives an incident ticket for an incident involving one of the plurality of computer products or computer systems from the service management platform for the computer product or the computer system, provides incident information from the incident ticket to the trained incident response machine learning engine, wherein the trained incident response machine learning engine is trained to predict a solution for the incident based on historical incident data, receives, from the trained incident response machine learning engine, a predicted solution for the incident, and provides the predicted solution to the service management platform; and the service management platform provides the predicted solution to the computer product or the computer system.

In one embodiment, the incident ticket may identify a description of the incident and/or a labelling of product/incident type.

In one embodiment, the trained incident response machine learning engine may be trained by the incident response computer program receiving the historical incident data, training the trained incident response machine learning engine using a first portion of the historical incident data, verifying the training of the trained incident response machine learning engine using a second portion of the historical incident data, and deploying the verified incident response machine learning engine to a production environment.

In one embodiment, the historical incident data may include, for a plurality of prior incidents, a description of the prior incident, a labelling of the product involved in the prior incident, a system involved in the prior incident, an individual involved in the prior incident, a team involved in the prior incident, a time and date of the prior incident, solutions to the prior incident, results of the solution, network environment data at the time of the prior incident, etc.

In one embodiment, the predicted solution may include a self-service troubleshooting guide for the predicted solution, product frequently asked questions (FAQs) for the predicted solution, solution instructions for the predicted solution, scripts for the predicted solution, patches for the predicted solution, configurations for the predicted solution, and/or solution articles for the predicted solution.

In one embodiment, the incident response computer program may receive feedback for the predicted solution and may re-train the trained incident response machine learning engine with the feedback.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 depicts a system for incident response using artificial intelligence for information technology operations according to an embodiment.

FIG. 2 depicts a method for training an incident response system using artificial intelligence for information technology operations according to embodiments.

FIG. 3 depicts method for incident response using artificial intelligence for information technology operations according to an embodiment.

FIG. 4 depicts method for incident response using artificial intelligence for information technology operations according to another embodiment.

FIG. 5 depicts an exemplary computing system for implementing aspects of the present disclosure.

### DETAILED DESCRIPTION OF PREFERRED EMBODIMENTS

Embodiments are directed to systems and methods for incident response using artificial intelligence for information technology operations.

As more and more customers are internally onboarded to cloud environments, embodiments provide an automated solution that predicts resolution based on the description of the incident and respond to the incidents without human involvement.

Embodiments provide a cloud native artificial intelligence for information technology operations (AIOps) that train and serve Natural Language Processing (NLP) models that are leveraged to respond to technology incidents.

Embodiments may receive incident data from a service management platform that captures and logs incident tickets. Each incident may be categorized and mapped to products and/or issues based on the description included on the tickets. (AWS, Kafka, NLP).

Embodiments may train a classification model and may deploy the classification model to the production environment.

In the production environment, embodiments may receive incidents in real-time from the service management platform and may update the service management platform with a predicted solution without human intervention.

Embodiments may monitor the performance of the model to proactively improve the accuracy rate of the solutions identified by the model.

Embodiments may reduce the mean time to resolution, often a key metric in the Service Level Agreement (SLA) for incident management, thereby positively impacting system uptime and productivity that lead to bottom line savings.

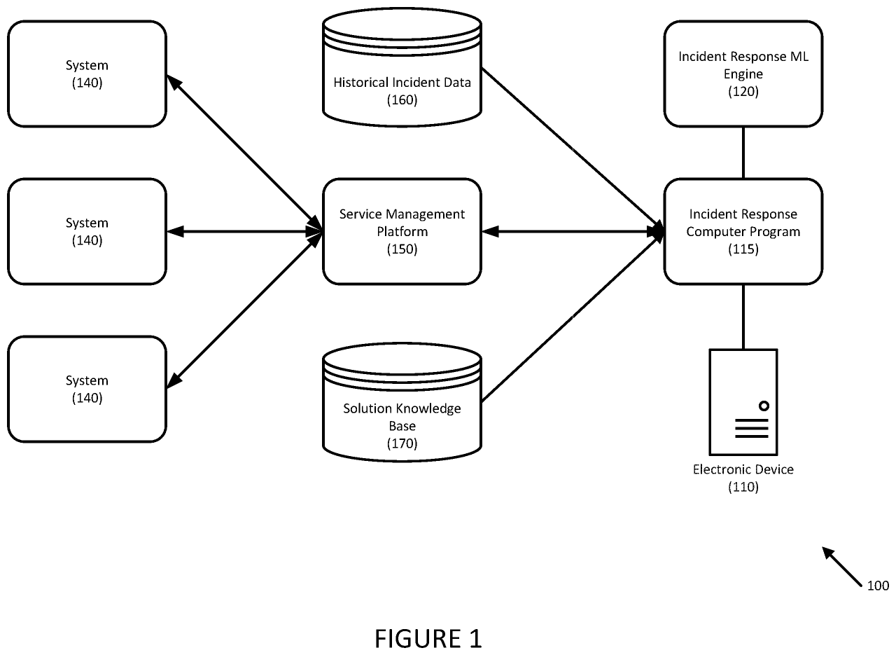

Referring to FIG. 1, a system for incident response using artificial intelligence for information technology operations is disclosed according to embodiments. System 100 may include electronic device 110, which may be any suitable electronic device, including servers (e.g., cloud-based and/or physical), computers (e.g., workstations, desktops, laptops, notebooks, tablets, etc.), smart devices, Internet of Things appliances, etc.

Electronic device 110 may execute incident response computer program 115, which may receive historical data from historical incident data source 160. In one embodiment, historical incident data source 160 may maintain historical incident data for prior incidents and solutions thereto. For example, the historical incident data may include a short and a long description of the incident, a labelling of a product or incident type, a system involved, an individual and/or team involved, a time and date of the incident, any attempted solutions, the results of the solutions, network environment data at the time of the incident, etc.

Incident response computer program 115 may train incident response machine learning (ML) engine 120 with the historical incident data using, for example, supervised training. For example, a first portion of the historical incident data may be used to train incident response ML engine 120, and a second portion of the historical incident data may be used to validate the training of incident response ML engine 120.

In one embodiment, the historical training data may be for a certain time period, such as 6-12 months. This time period is exemplary only.

Incident response computer program 115 may receive incident tickets from service management platform 150. Service management platform 150 may receive incident tickets from users, systems, etc. in response to the occurrence of an incident involving one of computer systems 140. The incident tickets may include a short and long description of the incident, the team and/or individual incident assigned to, labelling of product/incident type, etc. In one embodiment, the incident ticket may also include information about the network, the computing systems involved, etc.

Incident response computer program 115 may receive potential solution information from solution knowledge base 170. Solution knowledge base 170 may include, for example, self-service troubleshooting guides, product frequently asked questions (FAQs), solution instructions, scripts, patches, configurations, solution articles, etc.

Once incident response ML engine 120 identifies a solution, incident response computer program 115 may retrieve information from the identified solution from solution knowledge base 170, and may provide the solution with the information to service management platform 150. Service management platform 150 may provide the information to affected system 140.

In one embodiment, incident response computer program 115 may cluster tickets from service management platform 150 based on the incident type, systems involved, etc. If the number of tickets or the velocity of tickets exceeds a threshold, which may represent an outage, incident response computer program 115 may escalate the incident to a higher priority. This escalation may also send an alert to an operational team to address a potential outage.

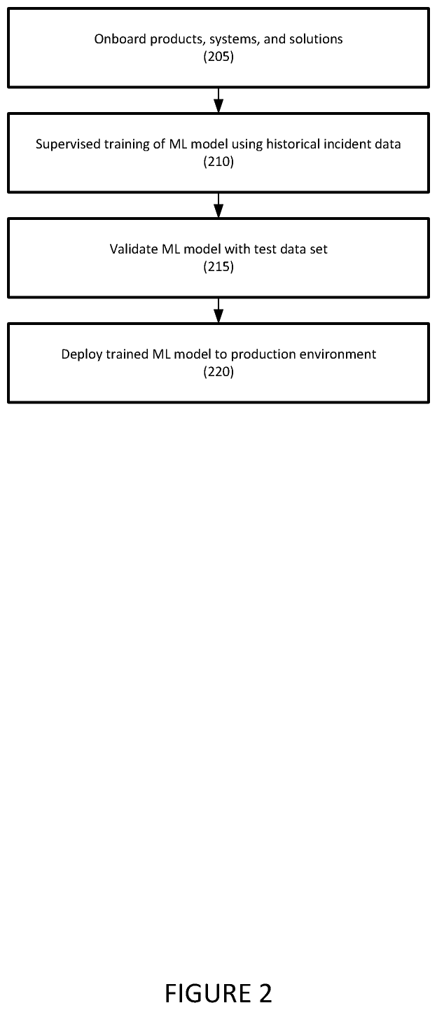

Referring to FIG. 2, a method for training an incident response system using artificial intelligence for information technology operations is disclosed according to embodiments.

In step 205, a computer program, such as an incident response computer program, may onboard products and/or systems within an organization. For example, the computer program may upload information regarding different software products and/or systems in a computer network. The computer program may also upload solutions, such as knowledge base articles, that may provide solutions to incidents involving the products and/or systems.

In step 210, the computer program may perform supervised training of an incident response machine learning engine using historical incident data. For example, the historical incident data may include a short and a long description of the incident, a labelling of a product or incident type, a system involved, an individual and/or team involved, a time and date of the incident, any attempted solutions, the results of the solutions, network environment data at the time of the incident, etc. The solution may include self-service troubleshooting guides, product frequently asked questions (FAQs), solution instructions, scripts, patches, configurations, solution articles, etc.

In one embodiment, a first portion of the historical incident data may be used to train the incident response machine learning model.

In step 215, the computer program may validate the incident response machine learning engine. For example, a second portion of the historical incident data may be used to validate the incident response machine learning model.

In step 220, once the incident response machine learning model is validated, it may be deployed to a production environment.

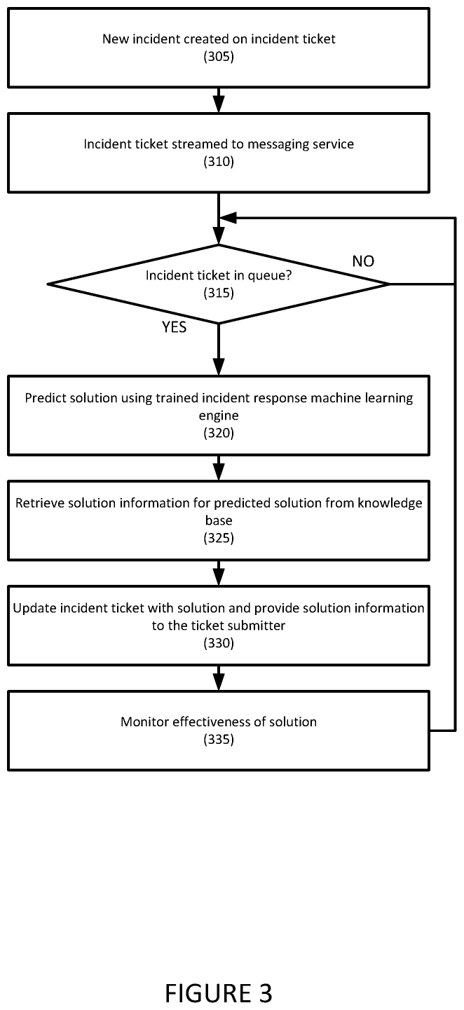

Referring to FIG. 3, a method for incident response using artificial intelligence for information technology operations is disclosed according to embodiments.

In step 305, an incident ticket for an incident with a computer program or system in a computer network may be created. For example, the incident ticket may be generated by a service management platform, which may interact with users, computer program, and systems within the computer network. The incident ticket may be manually created, or it may be generated automatically in response to the detection of an incident.

The incident tickets may include a short and long description of the incident, the team and/or individual incident assigned to, labelling of product/incident type, etc. In one embodiment, the incident ticket may also include information about the network, the computing systems involved, etc.

In step 310, the incident ticket may be streamed by a messaging service, such as Kafka.

In step 315, a computer program, such as an incident response computer program, may check the messaging service queue for an incident ticket. If there is an incident ticket in the queue, in step 320, the computer program may provide details from the incident ticket to a trained incident response machine learning engine, which may predict a solution to the incident.

In step 325, the computer program may retrieve information for the solution from, for example, a knowledge base. The information for the predicted solution may include solution instructions, scripts, patches, configurations, solution articles, etc.

In step 330, the computer program may update incident ticket with the solution information for the predicted solution, and may provide the solution information to the incident ticket submitter.

In step 335, the computer program may receive feedback from the incident ticket submitter as to the effectiveness of the solution. The feedback may be provided manually by the ticket submitter, may be automatically captured (e.g., metrics from the computer program or system indicate that the solution was successful), etc.

The feedback may be used to re-train or update the incident response machine learning engine as needed.

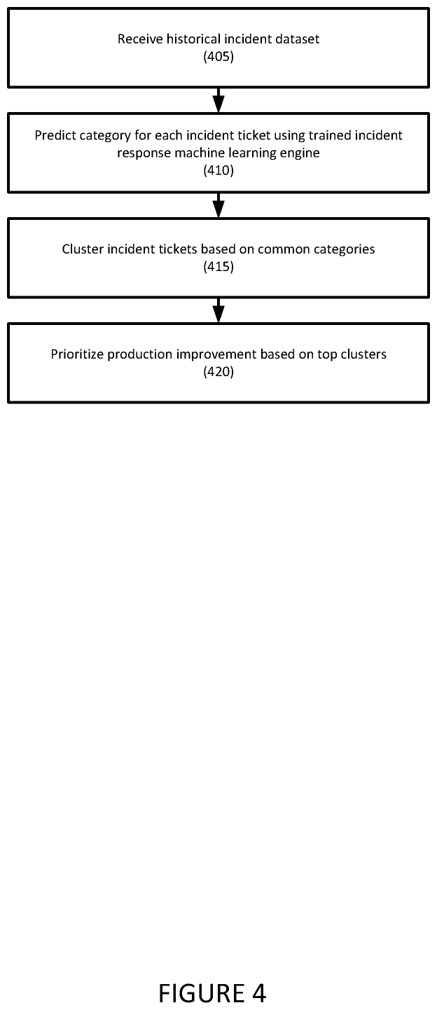

FIG. 4 depicts a method for incident response using artificial intelligence for information technology operations according to another embodiment.

In step 405, a computer program, such as an incident response computer program, may receive a historical incident dataset. In one embodiment, the historical incident dataset may include incident tickets for a certain time period, such as the prior 6 to 12 months. In one embodiment, the incident tickets may be for all incidents, only unresolved incidents, etc.

In one embodiment, the incident tickets in the historical incident dataset may be removed after a certain period (e.g., 6 months, 12 months), etc., and new incident tickets may be added.

In step 410, the computer program may predict a category for each incident ticket in the historical incident database using, for example, a trained incident response machine learning engine. For example, the incident response machine learning engine may be trained to predict a category for an incident associated with each incident ticket, such as a program, a system, a geography, etc. An incident ticket may be classified into more than one category as necessary.

In step 415, the computer program may cluster incident tickets based on a common issue, a common software program, a common system, a common geography, a common solution, etc.

In step 420, the computer program may prioritize improving the production quality for programs or applications by ranking or prioritizing the incident clusters based on the number of incident tickets in the clusters. This ranking or prioritization may be used to prioritize efforts at improving systems, programs, etc.

In another embodiment, the clusters may be ranked or prioritized based on a severity or impact of the incident (e.g., incidents with a higher severity or impact may have a lower threshold than those that do not), an impact on a business line (e.g., incidents involving client-facing programs or systems may have a lower threshold than those that are not client-facing), etc.

The clusters may be reset periodically, in response to no incident tickets being added to the cluster for a certain period of time (e.g., 12 hours), or as is necessary and/or desired.

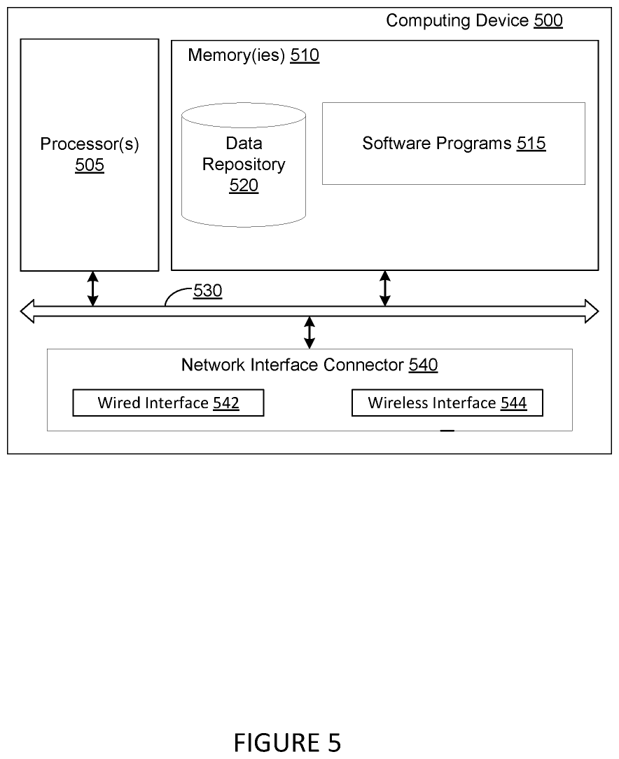

FIG. 5 depicts an exemplary computing system for implementing aspects of the present disclosure. FIG. 5 depicts exemplary computing device 500. Computing device 500 may represent the system components described herein. Computing device 500 may include processor 505 that may be coupled to memory 510. Memory 510 may include volatile memory. Processor 505 may execute computer-executable program code stored in memory 510, such as software programs 515. Software programs 515 may include one or more of the logical steps disclosed herein as a programmatic instruction, which may be executed by processor 505. Memory 510 may also include data repository 520, which may be nonvolatile memory for data persistence. Processor 505 and memory 510 may be coupled by bus 530. Bus 530 may also be coupled to one or more network interface connectors 540, such as wired network interface 542 or wireless network interface 544. Computing device 500 may also have user interface components, such as a screen for displaying graphical user interfaces and receiving input from the user, a mouse, a keyboard and/or other input/output components (not shown).

The disclosures of U.S. Provisional Patent Application Ser. Nos. 63/126,935 and 63/138,951, U.S. patent application Ser. No. 17/538,763, and U.S. patent application Ser. No. 17/664,579 are hereby incorporated, by reference, in their entireties.

Although several embodiments have been disclosed, it should be recognized that these embodiments are not exclusive to each other, and features from one embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for incident response using artificial intelligence for information technology operations, comprising:
receiving, by an incident response computer program executed by an electronic device, an incident ticket for an incident involving a computer product or a computer system within an organization from a service management platform for the computer product or the computer system;
providing, by the incident response computer program, incident information from the incident ticket to a trained incident response machine learning engine, wherein the trained incident response machine learning engine is trained to predict a solution for the incident based on historical incident data;
receiving, by the incident response computer program and from the trained incident response machine learning engine, a predicted solution for the incident; and
providing, by the incident response computer program, the predicted solution to the service management platform;
wherein the service management platform provides the predicted solution to the computer product or the computer system.

2. The method of claim 1, wherein the incident ticket identifies a description of the incident and/or a labelling of product/incident type.

3. The method of claim 1, further comprising training the trained incident response machine learning engine, comprising:
retrieving, by the incident response computer program, the historical incident data comprising a plurality of prior incidents;
training, by the incident response computer program, the trained incident response machine learning engine using a first portion of the historical incident data;
verifying, by the incident response computer program, the training of the trained incident response machine learning engine using a second portion of the historical incident data; and
deploying, by the incident response computer program, the verified incident response machine learning engine to a production environment.

4. The method of claim 3, wherein the historical incident data comprises, for each of the plurality of prior incidents, a description of the prior incident, a labelling of a product involved in the prior incident, a system involved in the prior incident, an individual involved in the prior incident, a team involved in the prior incident, a time and date of the prior incident, solutions to the prior incident, and/or results of the solution.

5. The method of claim 4, wherein the historical incident data further comprises, for the plurality of prior incidents, network environment data at the time of the prior incident.

6. The method of claim 1, wherein the predicted solution comprises a self-service troubleshooting guide for the predicted solution, product frequently asked questions (FAQs) for the predicted solution, solution instructions for the predicted solution, scripts for the predicted solution, patches for the predicted solution, configurations for the predicted solution, and/or solution articles for the predicted solution.

7. The method of claim 1, further comprising:
receiving, by the incident response computer program, feedback for the predicted solution; and
re-training, by the incident response computer program, the trained incident response machine learning engine with the feedback.

8. A method for incident response using artificial intelligence for information technology operations, comprising:
receiving, by an incident response computer program executed by an electronic device, a plurality of incident tickets for incidents involving computer products or computer systems within an organization from a service management platform for the computer products or the computer systems;
predicting, by the incident response computer program executed by an electronic device and using a trained incident response machine learning engine that is trained to predict a category for each incident ticket, a category for each of the plurality of incident tickets;
clustering, by the incident response computer program, the plurality of incident tickets into common incident clusters according to the categories;
ranking, by the incident response computer program, the common incident clusters based on a number of incident tickets in each common incident cluster; and
prioritizing, by the incident response computer program, improvement of production quality for programs or applications based on the ranking.

9. The method of claim 8, wherein the incident ticket identifies a description of the incident and/or a labelling of product/incident type.

10. The method of claim 8, wherein the categories comprise a common issue, a common software program, a common computer system, a common geography, and a common solution.

11. The method of claim 8, wherein the common incident clusters are further ranked based on a severity or impact of the incident in each common incident cluster.

12. A system, comprising:
a plurality of computer products or computer systems;
a service management platform in communication with each of the plurality of computer systems;
a solution knowledge base; and
an electronic device executing an incident response computer program and a trained incident response machine learning engine;
wherein:
the incident response computer program receives an incident ticket for an incident involving one of the plurality of computer products or computer systems from the service management platform for the computer product or the computer system;
the incident response computer program provides incident information from the incident ticket to the trained incident response machine learning engine, wherein the trained incident response machine learning engine is trained to predict a solution for the incident based on historical incident data;
the incident response computer program receives, from the trained incident response machine learning engine, a predicted solution for the incident;
the incident response computer program provides the predicted solution to the service management platform; and
the service management platform provides the predicted solution to the computer product or the computer system.

13. The system of claim 12, wherein the incident ticket identifies a description of the incident and/or a labelling of product/incident type.

14. The system of claim 12, wherein the trained incident response machine learning engine is trained by the incident response computer program receiving the historical incident data, training the trained incident response machine learning engine using a first portion of the historical incident data, verifying the training of the trained incident response machine learning engine using a second portion of the historical incident data, and deploying the verified incident response machine learning engine to a production environment.

15. The system of claim 14, wherein the historical incident data comprises, for a plurality of prior incidents, a description of the prior incident, a labelling of the product involved in the prior incident, a system involved in the prior incident, an individual involved in the prior incident, a team involved in the prior incident, a time and date of the prior incident, solutions to the prior incident, and/or results of the solution.

16. The system of claim 15, wherein the historical incident data further comprises, for the plurality of prior incidents, network environment data at the time of the prior incident.

17. The system of claim 12, wherein the predicted solution comprises a self-service troubleshooting guide for the predicted solution, product frequently asked questions (FAQs) for the predicted solution, solution instructions for the predicted solution, scripts for the predicted solution, patches for the predicted solution, configurations for the predicted solution, and/or solution articles for the predicted solution.

18. The system of claim 12, wherein the incident response computer program receives feedback for the predicted solution and re-trains the trained incident response machine learning engine with the feedback.
